(19) United States
(12) Patent Application Publication
(10) Pub. No.: US 2013/0006747 A1
(43) Pub. Date: Jan. 3, 2013

(54) System and method for providing online group-buying services

(75) Inventor: Bo Wu, Beijing (CN)

(73) Assignee: LaShou Group INC.

(21) Appl. No.: 13/135,193

(22) Filed: Jun. 28, 2011

(51) Int. Cl. G06Q 30/00

(52) U.S. Cl. 705/14.35; 705/26.2; 705/14.39; 705/26.44

(57) ABSTRACT

A system and method for providing online group-buying service is proposed. A group-buying company negotiates with a merchant to select a featured item to be sold on a group-buying website. The group-buying company and the merchant execute a binding agreement with regard to the feature item. The featured item is a product or service provided by the merchant to the group-buying company conditioned upon a first number of minimum sales. The group-buying company then advertises the feature item, and receives a number of orders from consumers purchasing the featured item. The group-buying company calculates a total number of sales and thereby determining a required remaining number of sales based on a second number of minimum sales. The group-buying company then processes the purchase orders if the required remaining number of sales has been reached.

### TECHNICAL FIELD

The present invention relates generally to e-commerce and, more particularly, to system and method for online group-buying services.

### BACKGROUND

Group buying, also known as collective buying, offers products and services at significantly reduced price on the condition that a minimum number of buyers would make the purchase. Origins of Group buying can be traced to China where Tuangou or team buying was executed to get discount prices from retailer when a large group of people were willing to buy at the same item. In recent time, Group-buying websites have emerged as a major player in online shopping business. Typically, these websites feature a deal of the day, with the deal kicking in once a set number of people agree to buy the product or service. Buyers then print off a voucher to claim their discount at the retailer. Many of the group-buying sites work by negotiating deals with local merchants and promising to deliver crowds in exchange for discounts. Group-buying sites are back in demand as small businesses look for ways to promote their products to budget-conscious consumers in a weak global economy.

Under Tuángòu, an item must be bought in a minimum quantity or dollar amount, otherwise the seller will not allow the purchase. Since individuals typically do not need multiples of one item or do not have the resources to buy in bulk, group buys allow people to invite others to purchase in bulk jointly. These group buys often result in better prices for the individual buyers or ensure that a scarce or obscure item is available for sale. If subscribers to a discount website are tempted by a discount offer, they enter their payment details online and wait. Once a minimum number of people sign up for the same offer, the deal is confirmed and a voucher is sent to their inboxes. Shops, restaurants and other retailers that partner with these discount websites have to take hefty price cuts. But it means they have instant access to a whole new group of customers.

Groupon (a portmanteau derived from “group coupon”) is a deal-of-the-day website that features discounted gift certificates usable at local or national companies. The company offers one “Groupon” (“group coupon”) per day in each of the markets it serves. The Groupon works as an assurance contract using The Point's platform: if a certain number of people sign up for the offer, then the deal becomes available to all buyers. On the other hand, if the predetermined minimum (e.g., the tipping point) is not met, then no one gets the deal that day. This reduces risk for retailers, who can treat the coupons as quantity discounts as well as sales promotion tools. There are potential problems with the business model. For example, a successful deal could temporarily swamp a small business with too many customers, risking a possibility that customers will be unsatisfied, or that there won't be enough product to meet the demand. On the other hand, frequently unsuccessful deals bring negative experience for the consumers, who are not able to get the discount product or service as they hoped for.

### SUMMARY

A system and method for providing online group-buying service is proposed. A group-buying company negotiates with a merchant to select a featured item to be sold on a group-buying website. The group-buying company and the merchant execute a binding agreement with regard to the feature item. The featured item is a product or service provided by the merchant to the group-buying company conditioned upon a first number of minimum sales. The group-buying company then advertises the feature item, and receives a number of orders from consumers purchasing the featured item. The group-buying company calculates a total number of sales and thereby determining a required remaining number of sales based on a second number of minimum sales. The group-buying company then processes the purchase orders if the required remaining number of sales has been reached.

In one embodiment, the merchant requires the first minimum number of sales, and the group-buying company requires no minimum number of sales (e.g., the second minimum number of sales equals to zero) for the deal to go through. If the total number of sales does not reach the first minimum number of sales, then the group-buying company guarantees the expected profit of the merchant and the deal goes through.

In another embodiment, the group-buying company requires the first minimum number of sales, and the merchant requires no minimum number of sales (e.g., the second minimum number of sales equals to zero) for the deal to go through. If the total number of sales does not reach the first minimum number of sales, then the merchant guarantees the expected profit of the group-buying company and the deal goes through.

In yet another embodiment, the merchant requires the first minimum number of sales, and the group-buying requires the second minimum number of sales, or vice versa. The second minimum number is lower than the first minimum number. If the total number of sales does not reach the first minimum number of sales but reaches the second minimum number of sales, then the entity requires the second minimum number of sales guarantees the expected profit of the entity that requires the first minimum number of sales and the deal goes through. In one example, a required minimum number is communicated to consumers via the group-buying website. In another example, even if the required minimum number is not reached, the deal is still on and the merchant provides the ordered product/service to consumers.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an online group-buying system in accordance with one novel aspect.

FIG. 2 is a detailed online group-buying procedure using a novel group-buying mechanism.

FIG. 3 is a simplified group-buying webpage displaying a list of featured products/services.

FIG. 4 is a simplified group-buying webpage featuring a specific product/service.

FIG. 5 is a flow chart of a first embodiment of a group-buying mechanism with internal tipping point in accordance with one novel aspect.

FIG. 6 is a flow chart of a second embodiment of a group-buying mechanism with internal tipping point in accordance with one novel aspect.

FIG. 7 is a flow chart of a third embodiment of a group-buying mechanism in accordance with one novel aspect.

### DETAILED DESCRIPTION

Reference will now be made in detail to some embodiments of the invention, examples of which are illustrated in the accompanying drawings.

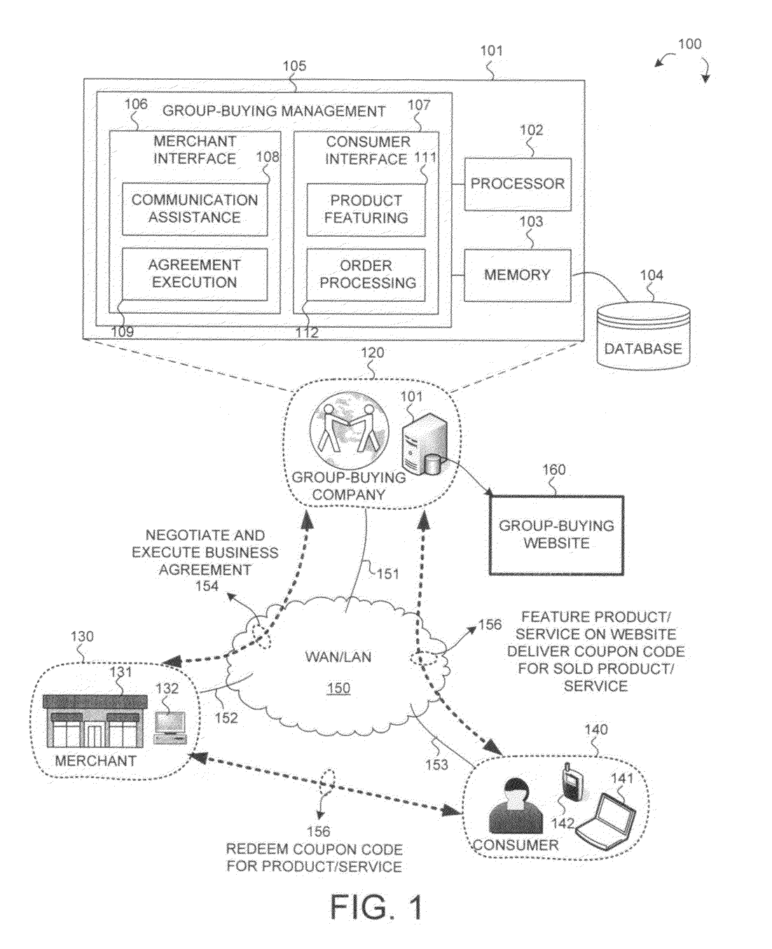

FIG. 1 illustrates an online group-buying system 100 in accordance with one novel aspect. Online group-buying system 100 comprises a group-buying company 120, a merchant 130, and a plurality of consumers (e.g., consumer 140 as illustrated in FIG. 1). Group-buying company 120 is an online seller that sells discounted products and services to large groups of consumers for sales campaigns made in a short duration of time via various online group-buying websites. For example, group-buying company 120 uses a server computer 101 to implement a particular group-buying sales campaign. Merchant 130 is a supplier that supplies the discount products or services to consumers via group-buying company 120. In one example, merchant 130 is a service provider that provides various services such as dining, lodging, or other entertaining activities at location 131. In another example, merchant 130 uses a client computer 132 to facilitate the communication with group-buying company 120 via server computer 101. Consumer 140 is a customer that purchases the discounted products or services via an online group-buying website (e.g., group-buying website 160 as illustrated in FIG. 1). For example, consumer 140 uses either a laptop client computer 141 and/or a cellular mobile phone 142 to browse the Internet and make purchase orders for products/services advertised by group-buying website 160.

In the example of FIG. 1, group-buying company 120 utilizes server computer 101 to provide online group-buying services. Server computer 101 comprises a processor 102, memory 103 coupled to a permanent database 104, and a group-buying management module 105 comprising a merchant interface 106 and a consumer interface 107. Merchant interface 106 comprises a communication assistance module 108 and an agreement execution module 109. Communication-assistance module 108 facilitates the communication between group-buying company 120 and merchant 130 (e.g., by email exchanges). Agreement execution module 109 facilitates the execution of a business agreement between group-buying company 120 and merchant 130 (e.g., by saving the final binding agreement). Consumer interface 107 comprises a product-featuring module 111 and an order processing module 112. Product-featuring module 111 features a product or service for sale via launching a group-buying website. Order-processing module 112 receives and processes purchase orders from the consumers.

The different modules within group-buying management module 105 are function modules that may be running on the same or different computer servers. The function modules, when executed by processor 102, allow online group-buying company 120 to negotiate and execute business deals with merchant 130, and to provide online group-buying services via group-buying websites to consumers via communication between server computer 101 and other client computers. In one embodiment, various activities are performed by exchanging communication messages in online group-buying system 100 via WAN/LAN 150 (e.g., the computers are connected to WAN/LAN 150 via wired or wireless links 151, 152, and 153 respectively). In a first example, group-buying company 120 and merchant 130 may communicate with each other and negotiate a business agreement via email exchanges between server computer 101 and client computer 132 (e.g., depicted by a thick dashed-line 154). In a second example, group-buying company 120 features a service on website 160 and delivers a coupon code to consumer 140 for the sold service (e.g., depicted by a thick dashed-line 155). In a third example, consumer 140 redeems the coupon code for the purchased service under instructions provided by merchant 130 (e.g., depicted by a thick dashed-line 156). All the activities performed by the different parties and all the information created and updated related to all the business transactions are saved by server computer 101 onto DB104.

In one novel aspect, the business agreement between group-buying company 120 and merchant 130 does not follow a traditional group-buying model with an explicit tipping point. Typically, buyers from a discount group-buying website place their purchase orders for a featured item offered at a discount price, and they enter their payment details online and wait. Once a minimum number of orders (e.g., the tipping pint) have been satisfied, the deal is confirmed and a voucher is then sent to the buyers. If the minimum number of orders has not been satisfied within a certain amount of time, however, the deal does not go through and the buyers do not get what they have hoped for. Frequently unsuccessful deals will bring negative experience for the consumers. To improve consumer buying experience, and to make more successful deals while still bring expected profit, a group-buying model with implicit tipping point is provide below.

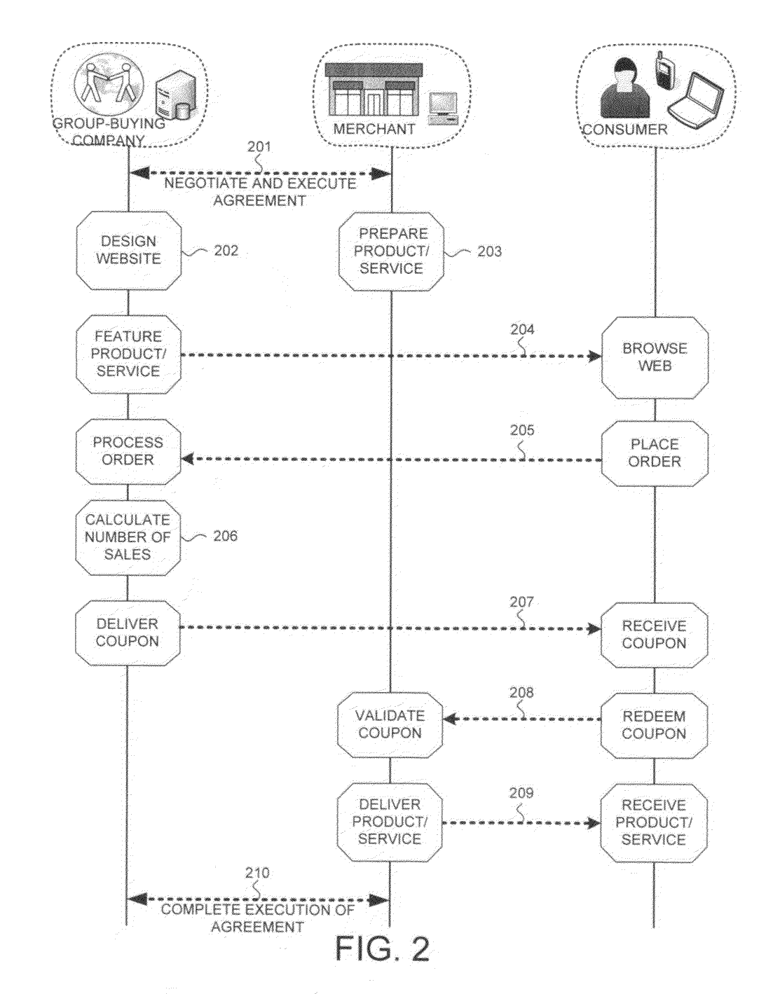

FIG. 2 is a detailed online group-buying procedure using a novel group-buying mechanism. In step 201, a group-buying company and a merchant negotiate and execute a business agreement. The process may include investigating the market and demand of a particular product/service (e.g., an item) in a geographic area and during a specific season/time, and negotiating with each other to reach a final agreement. The final agreement would include important contract information such as the to-be-featured product/service, price, minimum required quantity, expiration time, delivery method, and other conditions if applicable. Upon reaching the final agreement, the group-buying company starts to design a webpage for the featured item so that it can be launched for the group-buying sales campaign (step 202). Meanwhile, certain preparation may be performed at the merchant side to get ready for the featured item (step 203). In step 204, the featured item is launched at the website via a server computer, where buyers or subscribed members to the website can browse the featured item from the Internet and make purchase decisions. In step 205, a buyer places an order, and the server computer receives and processes the order. In step 206, the server computer calculates a total number of orders being processed, or a total number of sales items being purchased. If the deal goes through, then the buyer receives a voucher or a coupon code delivered by the group-buying company in step 207. Alternatively, if there is no minimum number of sales required for the deal, then the group-buying company delivers the voucher or coupon code to the buyer as soon as the order comes in. Before the specified expiration date, the buyer redeems the coupon and the merchant validates the coupon in step 208. Finally, the ordered product is delivered, or the ordered service is provided to the consumer in step 209. After the sales campaign is over, the group-buying company and the merchant complete the execution of the final agreement in step 210 (e.g., transfer sales proceeds). Based on the actual agreement, the group-buying company may make payment to the merchant in batches. For example, 50% of the payment may be made right after the end of the sales, another 30% may be made in a month, and the remaining 20% may be made in the final execution of the agreement.

The negotiation and execution of the final agreement is the most critical part in online group-buying business so that both parties can meet their business expectation while provide group-buying services to consumers with discount price, good quality, and overall satisfaction. From the group-buying company point of view, investigating in a new featured item, designing website, and providing post-sale services etc. are all associated with certain cost. Therefore, it is typically reasonable for a group-buying company to expect a minimum amount of profit from each featured item. Likewise, from the merchant point of view, a deeply discounted offer brings much smaller profit margin, and therefore normally needs to be offset by a large quantity of sales. As a result, both the group-buying company and the merchant may require a minimum number of sales in order for the deal to go through. The minimum number of required sales is typically included in the final agreement. From consumer point of view, however, it is discouraging when they place an order for a featured item but end up not getting the deal when the minimum number of required sales is not met. Therefore, it would be much appealing to consumer to buy discounted products/services that are not conditioned upon the minimum number of sales requirement.

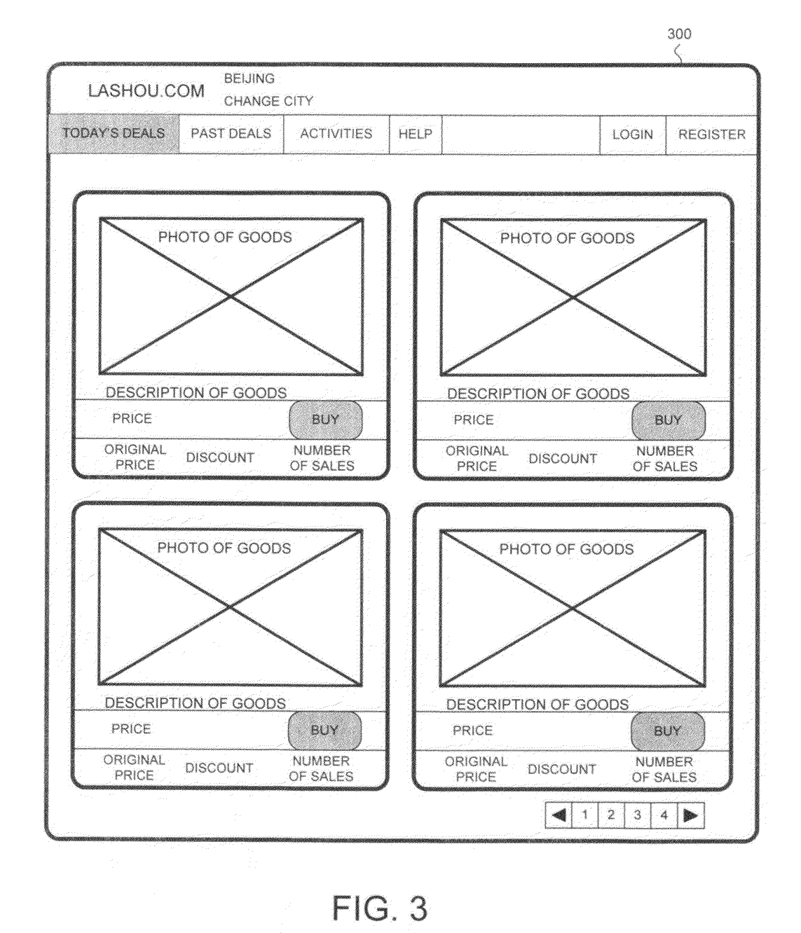

FIG. 3 is a simplified group-buying webpage 300 displaying a list of featured products/services. In the example of FIG. 3, webpage 300 displays a list of featured products/services as “today's deals”. Each featured item is represented by a photo of the goods, a brief description of the goods, the offered price, the original price, the discount percentage, and the total number of sales that has already occurred. A potential buyer can browse through all the featured items page by page quickly without getting detailed information. Once the potential buyer finds an item of interest, he/she can click the “buy” button, which will take him/her to another webpage that provides more detailed information about the selected product/service.

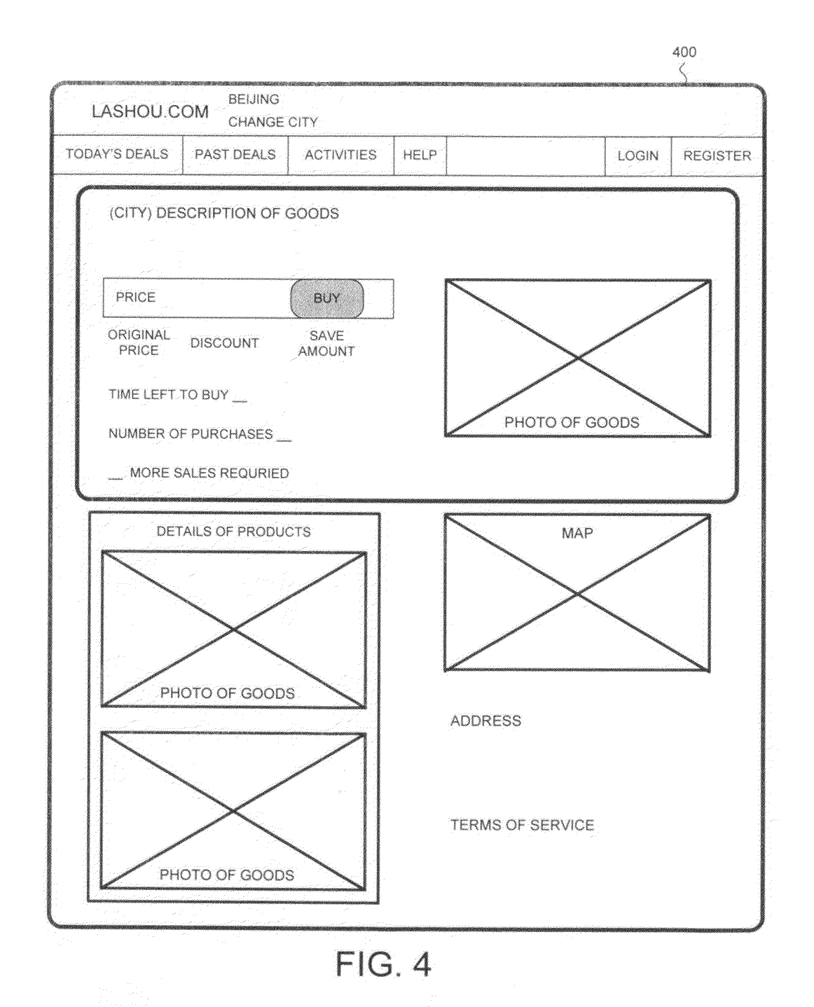

FIG. 4 is a simplified group-buying webpage 400 featuring a specific product/service. In the example of FIG. 4, webpage 400 displays detailed information of a featured item. The detailed information includes the basic information that displayed in webpage 300 of FIG. 3: a photo of goods, a brief description of the goods, the offered price, the original price, the discount percentage, and the total number of sales that has already occurred. In addition, the detailed information may include additional information such as the time left to buy and the number of sales required. Furthermore, additional photos may be displayed to describe different aspects of the featured item. If the featured item is service related, then information such as the address and map of location of the service may be displayed, and terms of the service provided may also be displayed to help the potential buyer to make purchase decision.

Although the number of sales required is displayed as one of the condition for a deal to go through, the novel group-buying model does not necessary require such minimum number imposed on the consumer. In some embodiments, there is no explicit required number of sales displayed to the consumer, even though the group-buying company and the merchant may establish one or more internal requirements in its final agreement. In other embodiments, the explicit minimum number of sales displayed to the consumer is different from (e.g., much lower than) the internal established requirements. Alternatively, even if the displayed minimum number of sales requirement is not met, the deal may still go through under certain circumstances. Different embodiments of the present invention are now described below.

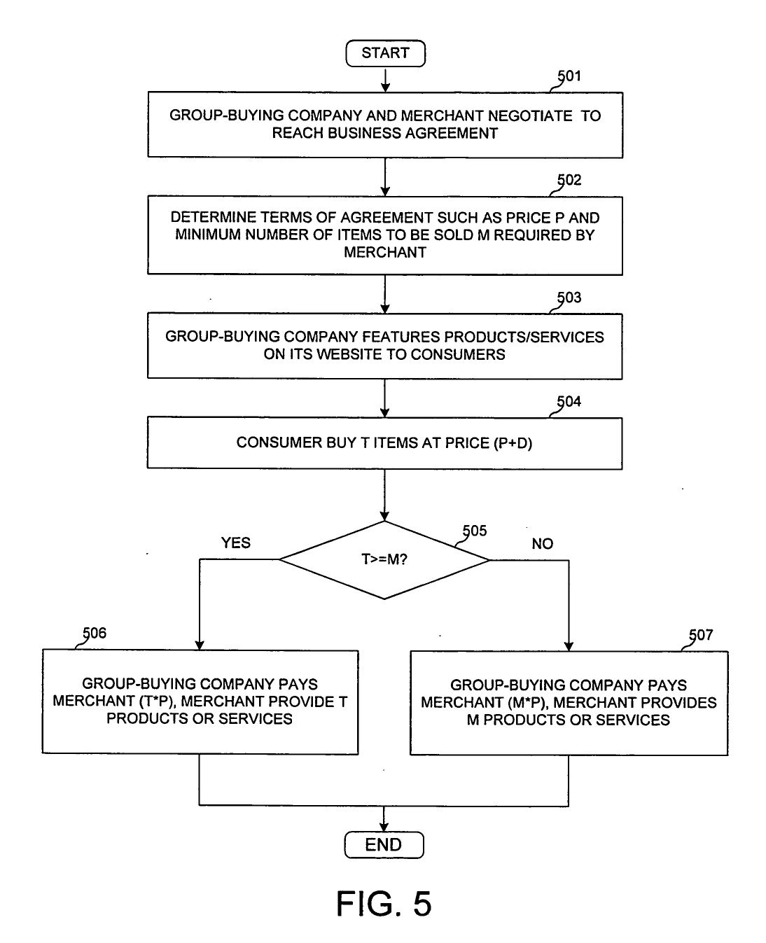

FIG. 5 is a flow chart of a first embodiment of a group-buying mechanism with internal tipping point in accordance with one novel aspect. In step 501, a group-buying company and a merchant negotiate to reach a business agreement for providing a discounted item via online group-buying. In the agreement, the group-buying company agrees to advertise the featured item through a group-buying website. The merchant agrees to supply the featured item. In step 502, terms of agreement are determined in the final agreement. In this first embodiment, the merchant requires the deal to be contingent upon a minimum number of sales (e.g., number M) to be sold at price P to the group-buying company. In step 503, the group-buying company features the product/service on its website to consumers for a predetermined sales period (e.g., a day or a week). In step 504, consumers buy the featured item at a new markup price (P+D). When more and more buyers place their orders, the total number of sold items T keeps increasing. At the end of the sales period, the total number T is compared with the minimum required number M (step 505). If the total number of sold items T exceeds the minimum required number M, then the group-buying company pays the merchant the sales proceeds (T*P) according to the contract terms, and the merchant supplies a quantity of T products/services (step 506). On the other hand, if the total number of sold item T is less than the minimum required number M, then the group-buying company pays the merchant the minimum guaranteed sales proceeds (M*P) according to the contract terms, and the merchant supplies M products/services (step 507). Regardless of how the actual sales goes, the deal always goes through because the group-buying company guarantees the minimum sales number requirement by taking its own risk.

In one example, a newly established group-buying company and a famous Movie Theatre agree to have a movie ticket sales campaign. The regular ticket price is $50,the Movie Theater agrees to sell a minimum 100,000 tickets to the group-buying company at price $20 (P=20, M=100,000). The group-buying company then uses various sales techniques trying to sell as many tickets as possible at price $25 (D=5). The various sales techniques may include extending expiration day for the tickets, bundling multiple featuring deals, and reducing the sales price. If more than 100,000 tickets are sold (e.g., T=102,000), then the group-buying company pays the Movie Theater T*20 and the Movie Theater supplies T tickets. Alternatively, the group-buying company and the Movie Theater may agree to share the profit from the extra sold tickets (e.g., share the $2000*5 extra profit) under the contract terms.

On the other hand, if less than 100,000 tickets are sold (e.g., T=98,000), then the group-buying company guarantees to pay the Movie Theater M*20. It is noted that although the minimum required number M is not met through the actual sale, the deal still goes through. The group-buying company guarantees the expected profit for the Movie Theater. For a newly-established group-buying company, it is willing to take such risk so that its name can be promoted to a large amount of potential new customers. In a first variation, the group-buying company pays the Movie Theater M*P (e.g., 100,000*20) upfront and the Movie Theater supplies M tickets. In a second variation, the group-buying company guarantees the Movie Theater its expected profit. If the Movie Theater expects to make $5 for each ticket, then the group-buying company pays the Movie Theater 98,000*20, plus $5 for each unsold ticket (e.g., 2,000*5), and the Movie Theater supplies T tickets. In one advantageous aspect, the minimum required number is an internal tipping point defined in the agreement between the group-buying company and the merchant. Such required minimum number, however, is not displayed on the webpage so that the buyers are more attracted to make the purchase decision knowing the deal is guaranteed.

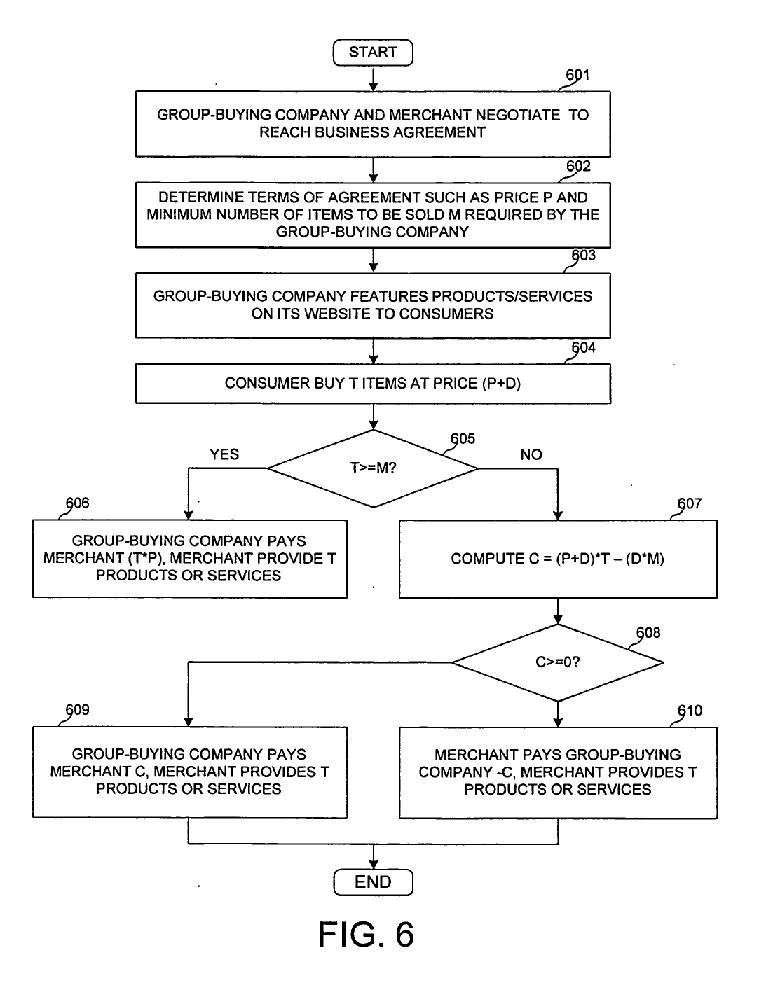

FIG. 6 is a flow chart of a second embodiment of a group-buying mechanism with internal tipping point in accordance with one novel aspect. In step 601, a group-buying company and a merchant negotiate to reach a business agreement for providing a discounted item via online group-buying. In the agreement, the group-buying company agrees to advertise the featured item through a group-buying website. The merchant agrees to supply the featured item. In step 502, terms of agreement are determined in the final agreement. In this second embodiment, the group-buying company requires the deal to be contingent upon a minimum number of sales (e.g., number M) to be sold at price P+D, where P is the price from the merchant to the group-buying company, and D is the markup by the group-buying company. Basically, the group-buying company expects to make M*D profit from this deal. In step 603, the group-buying company features the item on its website to consumers for a predetermined sales period (e.g., a day or a week). In step 604, consumers buy the featured item at the new markup price (P+D). When more and more buyers place their orders, the total number of sold items T keeps increasing. At the end of the sales period, the total number T is compared with the minimum required number M (step 605). If the total number of sold items T exceeds the minimum required number M, then the group-buying company pays the merchant the sales proceeds (T*P) according to the contract terms, and the merchant supplies a quantity of T products/services to the buyers (step 606).

On the other hand, if the total number of sold item T is less than the minimum required number M, then further calculation needs to be performed in step 607. The expected profit by the group-buying company is M*D, while the actual sales proceeds is T*(P+D). The calculated difference is thus C=T*(P+D)−M*D. In step 608, it is verified whether the calculated difference C is a positive number. If yes, then the group-buying company pays the merchant the difference C, and the merchant supplies T products/services (step 609). If no, then the merchant pays the group-buying company the difference −C, and provides T products/services (step 610). Regardless of the actual sales, the deal always goes through because the merchant guarantees the minimum sales number requirement by taking its own risk.

In one example, a newly-opened restaurant wants to promote a new lobster meal through a well-established group-buying website. The regular price of the lobster meal is $120, and is sold to the group-buying company for $50 (P=50) per meal, and is in turn sold to the consumer for $60 (D=10) per meal. Because the group-buying company expects to make a minimum profit of $5,000 from this deal, it thus requires a minimum number of 500 (M=500) meals to be sold. If only 400 meals (T=400) are sold, the deal still goes through and the restaurant guarantees the expected profit for the group-buying company. For a newly-opened restaurant, it is willing to take such risk so that its name can be promoted to a large amount of potential new customers.

There are several ways to realize the guarantee. In a first variation, the restaurant gives the group-buying company $5,000 upfront for promoting the sale, regardless of how many meals are sold. The sales price may be determined by the restaurant, and all the sales proceeds go to the restaurant. In a second variation, if the group-buying company expects to make $10 profit per meal, then the restaurant gives $10 for each unsold meal short of 500 (e.g.,(M−T)*10 =$1,000) to the group-buying company. In one advantageous aspect, the minimum required number of sales is an internal tipping point and is not displayed to the consumer. Alternatively, the required number of sales displayed to the consumer may be a different number (e.g., M′=100) that is much lower than the internal tipping point to encourage purchase decision. Furthermore, even if the displayed required number of sales is not satisfied, the deal still goes through.

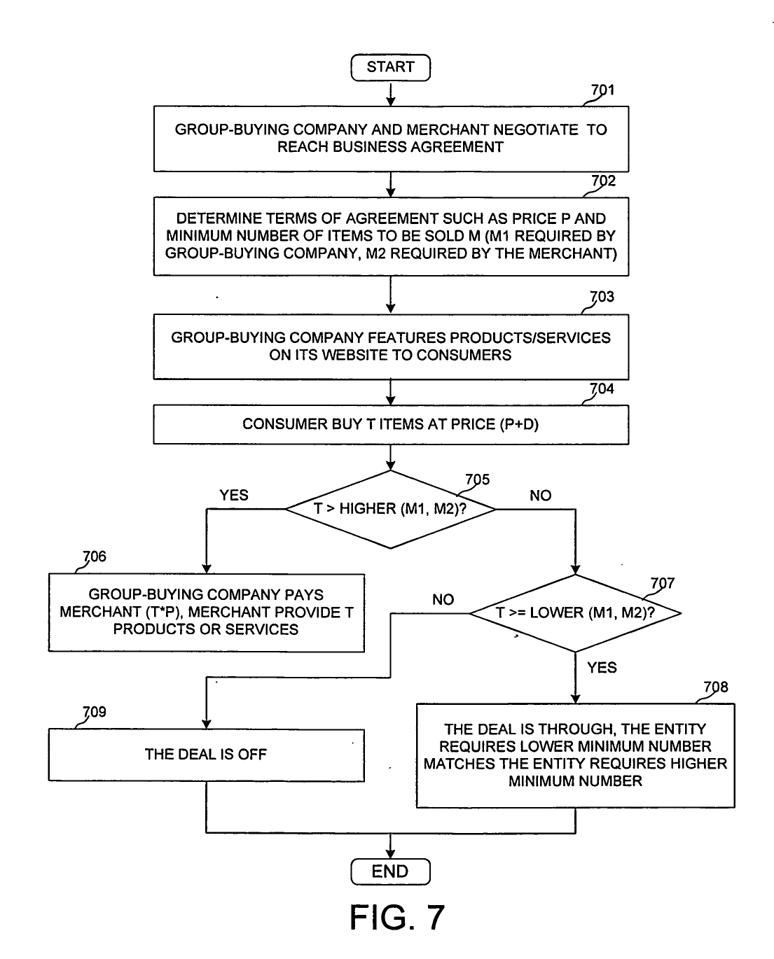

FIG. 7 is a flow chart of a third embodiment of a group-buying mechanism in accordance with one novel aspect. Step 701 through step 704 are similar to step 501 through 504 of FIG. 5 or step 601 through step 604 of FIG. 6. In the third embodiment of the novel group-buying mechanism, however, both the group-buying company and the merchant require a minimum number of sales in order for the deal to go through. For example, the group-buying company may require a first minimum number of sales (M1), and the merchant may require a second minimum number of sales (M2) (see step 702). In step 705, the total amount of sales T is compared with both M1 and M2. If T is higher than both M1 and M2, then the group-buying company pays the merchant the sales proceeds (T*P) according the contract terms, and the merchant supplies a quantity of T products/services (step 706). If T is not higher than both M1 and M2, it is determined whether T is higher than or equal to the lower of M1 and M2 in step 707. If yes, then the deal is through, the party that requires the lower minimum number guarantees the deal by matching the higher minimum number required by the other party (step 708), as illustrated with respect to FIG. 5 and FIG. 6. If T is lower than both Ml and M2, then the deal is off (step 709).

From the consumer perspective, the required minimum numbers (M1 and M2) are internal tipping point negotiated between the group-buying company and the merchant, and thus are not exposed to the consumer. In some embodiments, the webpage does not advertise any required minimum number of sales in order for the deal to go through. In other embodiments, the webpage advertise a much lower required number than the actual required minimum number. In yet other embodiments, even if the advertised required number is not satisfied, the deal still goes through and the consumer will receive their ordered products/services. Either one of the parties would take the risk of loss or both parties share the risk of loss under the pre-negotiated contract terms.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A computer-implemented method, comprising:
advertising, via a display screen, a featured item for sale, wherein the featured item is a product or service provided by a merchant to a group-buying company conditioned upon a first number of minimum sales;
receiving, via the display screen, a number of orders from consumers purchasing the featured item;
calculating a total number of sales and thereby determining a required remaining number of sales based on a second number of minimum sales; and
processing the purchase orders if the required remaining number of sales has been reached, wherein the second minimum number of sales is lower than the first minimum number of sales.

2. The method of claim 1, wherein the featured item is advertised for sale at a discount price much lower than a regular retail price.

3. The method of claim 1, wherein the featured item is advertised for sale during a limited amount of time period.

4. The method of claim 1, wherein the first minimum number is required by the group-buying company, and wherein the merchant guarantees the first minimum number of sales if the total number of sales is lower than the first number.

5. The method of claim 1, wherein the first minimum number is required by the merchant, and wherein the group-buying company guarantees the first minimum number of sales if the total number of sales is lower than the first number.

6. The method of claim 1, wherein the second number of minimum sales is zero, and wherein the purchase orders are not conditioned upon the total number of sales.

7. The method of claim 1, wherein the second number of minimum sales is not zero, and wherein the required remaining number of sales is displayed on the display screen and communicated to consumers.

8. A method of providing online group-buying service by a group-buying company, comprising:
negotiating with a merchant to select a featured item to be sold on a group-buying website;
executing an agreement with the merchant with regard to the featured item and thereby establishing agreement terms including guaranteeing a first number of minimum sales;
advertising the featured item on the group-buying website and thereby receiving orders from consumers purchasing the featured item; and
processing the orders if a total number of orders reaches a second number of minimum sales, wherein the second number is lower than the first number.

9. The method of claim 8, wherein the featured item is for sale at a discount price much lower than a regular retail price.

10. The method of claim 8, wherein the featured item is for sale during a limited amount of time period.

11. The method of claim 8, wherein the first minimum number is required by the group-buying company, and wherein the merchant guarantees the first minimum number of sales.

12. The method of claim 8, wherein the first minimum number is required by the merchant, and wherein the group-buying company guarantees the first minimum number of sales.

13. The method of claim 8, wherein the second number of minimum sales is zero, and wherein the purchase orders are not conditioned upon the total number of sales.

14. The method of claim 8, wherein the second number of minimum sales is not zero, and wherein the required remaining number of sales is displayed on the display screen and communicated to consumers.

15. A group-buying server system, comprising:
a product featuring module that advertises a discount item for sale via a group-buying website, wherein the discount item is a product or service provided by a merchant to a group-buying company conditioned upon a first number of minimum sales;
an order processing module that receives purchase orders, calculates a total number of sales and thereby determines a required remaining number of sales based on a second number of minimum sales, wherein the order processing module also processes the purchase orders if the required remaining number of sales has reached, and wherein the second minimum number of sales is lower than the first minimum number of sales.

16. The system of claim 15, further comprising:
a communication assistance module that assist negotiation between the group-buying company and the merchant to select the discount item to be sold on the group-buying website.

17. The system of claim 15, further comprising:
an agreement execution module that assist execution of an agreement between the group-buying company and the merchant, wherein the agreement includes guaranteeing the first number of minimum sales.

18. The system of claim 15, wherein the first minimum number is required by the group-buying company, and wherein the merchant guarantees the first minimum number of sales.

19. The system of claim 15, wherein the first minimum number is required by the merchant, and wherein the group-buying company guarantees the first minimum number of sales.

20. The system of claim 15, wherein the second number of minimum sales is zero, and wherein the purchase orders are not conditioned upon the total number of sales.

21. The system of claim 15, wherein the second number of minimum sales is not zero, and wherein the required remaining number of sales is displayed on a display screen and communicated to consumers.

22. The system of claim 15, wherein the purchase orders are processed even if the required remaining number of sales has not been reached.
